(19) United States
(12) Patent Application Publication
(10) Pub. No.: US 2018/0161985 A1
(43) Pub. Date: Jun. 14, 2018

(54) CONTROL DEVICE, ROBOT, AND ROBOT SYSTEM

(71) Applicant: Seiko Epson Corporation, Tokyo (JP)

(72) Inventor: Makoto KOBAYASHI, Azumino (JP)

(21) Appl. No.: 15/830,403

(22) Filed: Dec. 4, 2017

(30) Foreign Application Priority Data
Dec. 9, 2016 (JP) 2016-239107

(51) Int. Cl. B25J 9/16

(52) U.S. Cl. CPC B25J 9/1692; G05B 2219/39022; G05B 2219/40607; B25J 9/1697

(57) ABSTRACT

A control device, which controls a robot including a movable portion provided with a tool including a marker, includes: an obtaining portion which obtains a first captured image obtained by capturing an image of the marker by a movable first image capturing portion that captures an image of the marker; and a control portion which performs first corresponding between a coordinate system of the first image capturing portion and a coordinate system of the robot based on the first captured image obtained by the obtaining portion after the first image capturing portion has moved.

### BACKGROUND

### 1. Technical Field

The present invention relates to a control device, a robot, and a robot system.

### 2. Related Art

In the related art, a robot system including: a robot having a robot arm including an end effector that performs work with respect to a target and a camera attached to a tip end portion of the robot arm; and a control device that controls driving of the robot, is known.

As an example of the robot system, in JP-A-2005-300230, a measuring device including: a robot including an arm; a tool attached to an arm tip end portion of the robot; and a camera installed on the periphery of the robot, is disclosed. In the measuring device, a position of the tool with respect to a tool attachment surface of the robot is measured by using the camera. In addition, in general, the measured position of the tool is used in calibration between a coordinate system of the camera and a coordinate system of the robot.

Here, in the measuring device described in JP-A-2005-300230, the camera is provided to be fixed at a location on the periphery of the robot. Therefore, when measuring the position of the tool by the measuring device or executing the calibration, there is a concern that the robot interferes with a peripheral device according to the dispositional relationship between the robot and the peripheral device. As a result, there is a problem that it is not possible to accurately measure the position of the tool or to execute the calibration.

### SUMMARY

An advantage of some aspects of the invention is to solve at least a part of the problems described above, and the invention can be implemented as the following configurations.

A control device according to an aspect of the invention is a control device which controls a robot including a movable portion provided with a tool including a marker, including: an obtaining portion which obtains a first captured image obtained by capturing an image of the marker by a movable first image capturing portion that captures an image of the marker; and a control portion which performs first corresponding between a coordinate system of the first image capturing portion and a coordinate system of the robot based on the first captured image obtained by the obtaining portion after the first image capturing portion has moved.

In the control device according to the aspect of the invention, it is possible to perform the first corresponding (calibration) at a location at which the first image capturing portion is moved and does not interfere with the peripheral device or the like. Therefore, even in a relatively narrow region, it is possible to perform the first corresponding. In addition, since it is possible to perform the first corresponding in a state of being stopped after moving the first image capturing portion, it is not necessary to consider a moving direction of the first image capturing portion. Therefore, the first corresponding between the coordinate system of the first image capturing portion and the coordinate system of the robot is easily performed.

In the control device according to the aspect of the invention, it is preferable that the control portion performs the first corresponding at a plurality of positions.

With this configuration, by performing the first corresponding every time when the first image capturing portion is moved, it is possible to particularly improve the accuracy of the work of the robot at each location.

In the control device according to the aspect of the invention, it is preferable that the control portion performs the first corresponding at a first position, and controls driving of the robot by using the first corresponding at the first position, at a second position different from the first position.

With this configuration, since it is possible to acquire the first corresponding at the second position different from the first position based on data of the first corresponding at the first position, it is possible to save time and effort for performing the first corresponding at the second position, and it is also possible to improve the accuracy of the work of the robot at the second position similar to the work at the first position.

In the control device according to the aspect of the invention, it is preferable that 0.8≤R1/R2≤1.2 when the repeating accuracy in movement of the first image capturing portion is R1 and the repeating accuracy in work of robot is R2.

By satisfying the relationship, for example, it is possible to particularly improve the accuracy of the first corresponding at the plurality of positions based on the data of the first corresponding, for example, at one arbitrary position (first position). Therefore, it is possible to improve the accuracy of the work of the robot at the plurality of positions similar to the work at the arbitrary position (first position).

In the control device according to the aspect of the invention, it is preferable that, after the control portion performs second corresponding between a coordinate system of a second image capturing portion which captures an image of the marker and the coordinate system of the robot, the obtaining portion obtains a second captured image obtained by capturing an image of the marker by the second image capturing portion, and the control portion calculates a position of the marker in the coordinate system of the robot based on the second captured image obtained by the obtaining portion.

With this configuration, it is possible to easily and appropriately acquire the position of the marker with respect to a predetermined part (for example, a tool center point) of the robot, that is, the offset of the marker. Therefore, by using the offset of the marker, it is possible to appropriately perform the first corresponding.

In the control device according to the aspect of the invention, it is preferable that, after calculating the position of the marker in the coordinate system of the robot, the control portion calculates an offset between a predetermined part of the robot and the marker based on the position of the marker in the coordinate system of the robot, and performs the first corresponding based on the offset and the first captured image.

With this configuration, even when it is not possible to capture the predetermined part by the first image capturing portion, it is possible to appropriately perform the first corresponding based on the position of the marker and the offset.

In the control device according to the aspect of the invention, it is preferable that the marker is a transmitting portion having optical transmission properties.

With this configuration, for example, it is possible to clearly recognize an outline of the marker, to improve the image capturing accuracy of the first captured image, and to improve the measuring accuracy of the marker. Therefore, it is possible to perform the first corresponding with higher accuracy.

In the control device according to the aspect of the invention, it is preferable that the first image capturing portion is provided at a location different from the movable portion.

With this configuration, for example, it is possible to perform the first corresponding in the first image capturing portion provided on the periphery of the robot.

A robot according to an aspect of the invention includes: a movable portion which is controlled by the control device according to the aspect of the invention, and which is provided with a tool including a marker.

According to the robot, under the control of the control device, it is possible to accurately perform an operation related to the first corresponding.

A robot system according to an aspect of the invention includes: the control device according to the aspect of the invention; a robot which is controlled by the control device, and includes a movable portion provided with a tool including a marker; and a first image capturing portion having an image capturing function.

According to the robot system, it is possible to perform the first corresponding at a location at which the first image capturing portion is moved and does not interfere with the peripheral device or the like, and under the control of the control device, the robot can accurately perform the operation related to the first corresponding.

### BRIEF DESCRIPTION OF THE DRAWINGS

The invention will be described with reference to the accompanying drawings, wherein like numbers reference like elements.

FIG. 1 is a perspective view of a robot system according to a first embodiment of the invention.

FIG. 2 is a system configuration view of the robot system illustrated in FIG. 1.

FIG. 3 is a side view illustrating a robot included in the robot system illustrated in FIG. 1.

FIG. 4 is a side view illustrating a work space of the robot system illustrated in FIG. 1.

FIG. 5 is a perspective view illustrating a moving mechanism included in the robot system illustrated in FIG. 1.

FIG. 6 is a flowchart illustrating a flow of calibration performed by the robot system illustrated in FIG. 1.

FIG. 7 is a flowchart for describing step S11 illustrated in FIG. 6.

FIG. 8 is a view illustrating one example of a state of the robot in step S11 illustrated in FIG. 6.

FIG. 9 is a view illustrating a plurality of reference points used in step S11 illustrated in FIG. 6.

FIG. 10 is a schematic view of the robot for describing step S12 illustrated in FIG. 6.

FIG. 11 is a plan view of a jig attached to a robot arm included in the robot illustrated in FIG. 3.

FIG. 12 is a view illustrating one example of a state of the robot in step S12 illustrated in FIG. 6.

FIG. 13 is a view illustrating one example of a second captured image in step S12 illustrated in FIG. 6.

FIG. 14 is a reference view for describing step S12 illustrated in FIG. 6.

FIG. 15 is a flowchart for describing step S13 illustrated in FIG. 6.

FIG. 16 is a view illustrating one example of a state of the robot in step S13 illustrated in FIG. 6.

FIG. 17 is a view illustrating one example of a first captured image in step S13 illustrated in FIG. 6.

FIG. 18 is a flowchart for describing step S13 in calibration in a robot system according to a second embodiment of the invention.

### DESCRIPTION OF EXEMPLARY EMBODIMENTS

Hereinafter, a control device, a robot, and a robot system according to the invention will be described in detail based on appropriate embodiments illustrated in the attached drawings.

### First Embodiment

### Robot System

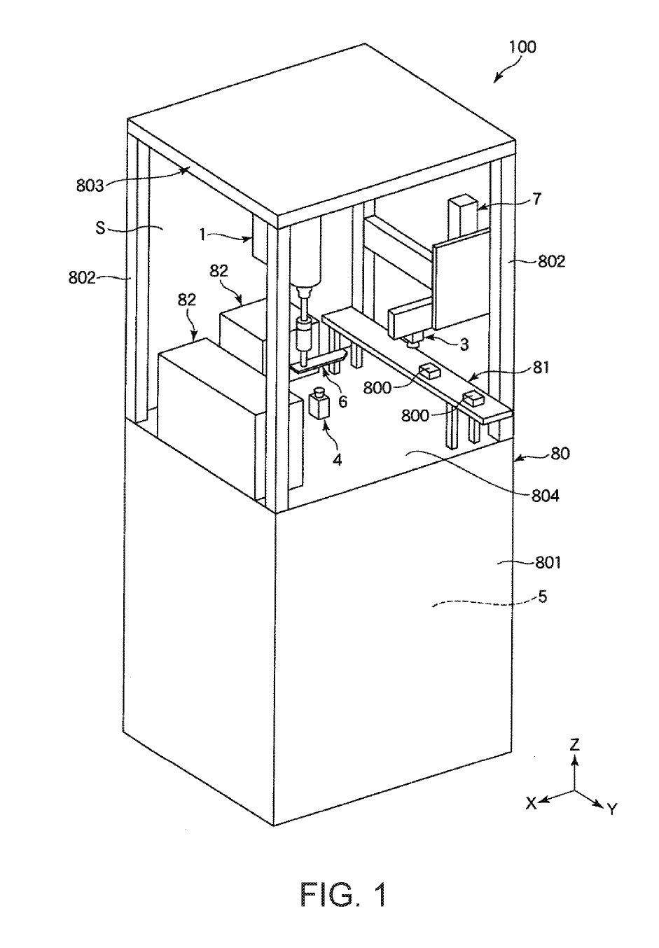

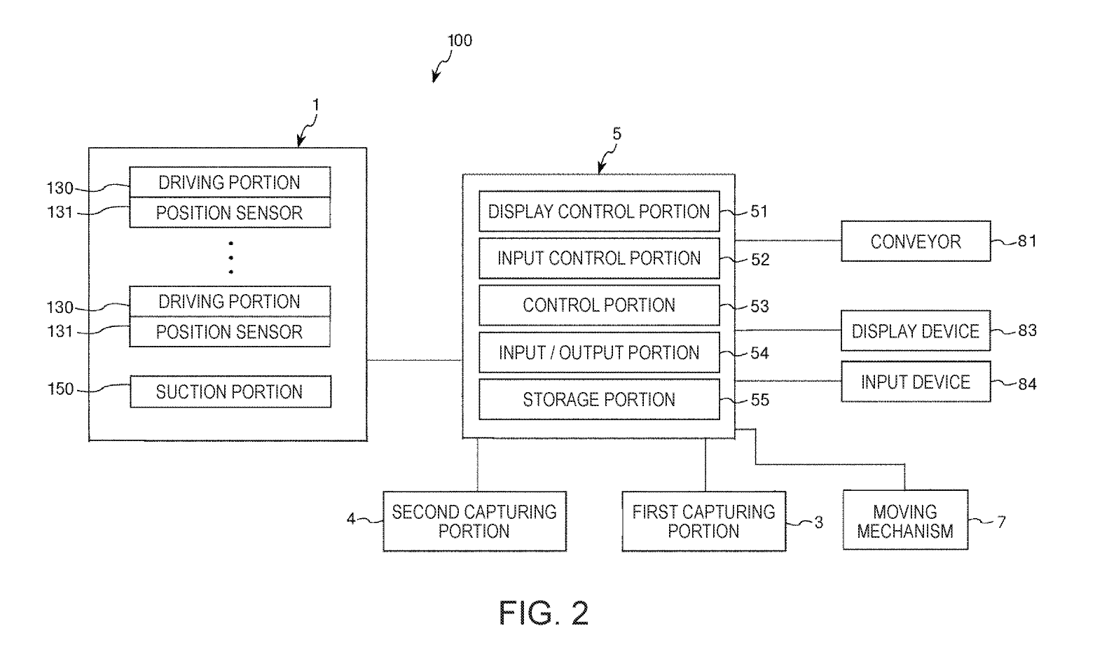

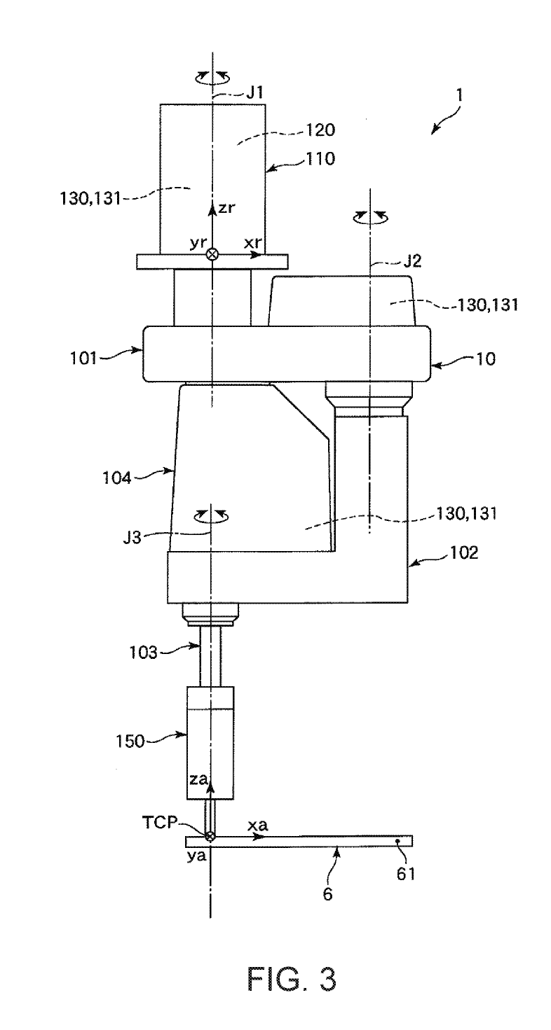

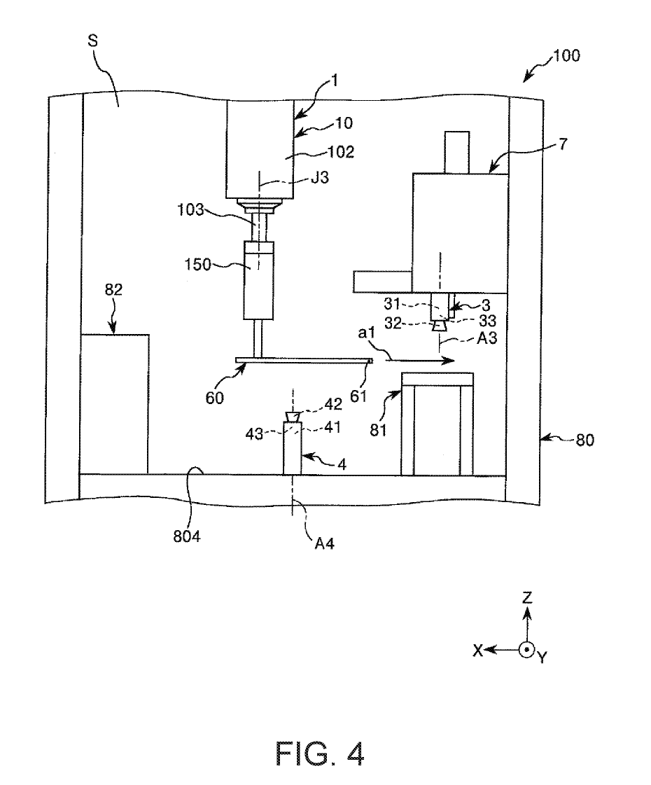

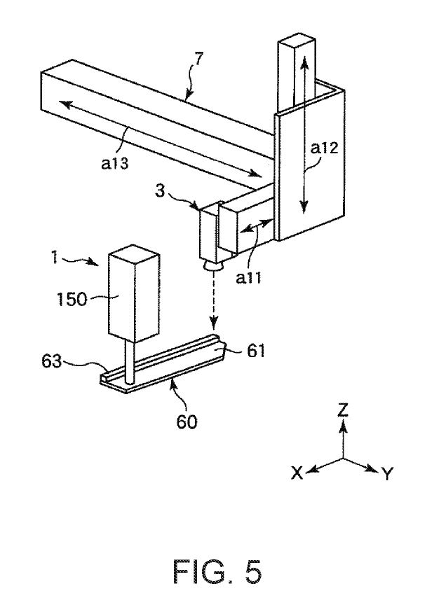

FIG. 1 is a perspective view of a robot system according to a first embodiment of the invention. FIG. 2 is a system configuration view of the robot system illustrated in FIG. 1. FIG. 3 is a side view illustrating a robot included in the robot system illustrated in FIG. 1. FIG. 4 is a side view illustrating a work space of the robot system illustrated in FIG. 1. FIG. 5 is a perspective view illustrating a moving mechanism included in the robot system illustrated in FIG. 1. In addition, hereinafter, for the convenience of the description, an upper side in FIG. 1 is referred to as “up”, and a lower side is referred to as “down”. In addition, for the convenience of the description, in FIG. 1, an X axis, a Y axis, and a Z axis which are three axes orthogonal to each other are illustrated by arrows, a tip end side of the arrow is referred to as “+(positive)”, and a base end side of the arrow is referred to as “−(negative)”. In addition, a base 110 side in FIG. 3 is referred to as “base end”, and a side opposite thereto (a suction portion 150 side which functions as an end effector) is referred to as “tip end”. In addition, an upward-and-downward direction of FIG. 1 is referred to as “vertical direction”, and a leftward-and-rightward direction is referred to as “horizontal direction”. In the specification, “horizontal” includes not only a case of being completely horizontal but also a case of being inclined within ±5° with respect to the horizontal state. Similarly, in the specification, “vertical” includes not only a case of being completely vertical but also a case of being inclined within ±5° with respect to the vertical state. In addition, in the specification, “parallel” includes not only a case where two lines (including axes) or surfaces are completely parallel to each other but also a case where the two lines (including axes) or surfaces are inclined by ±5°. In addition, in the specification, “orthogonal” includes not only a case where two lines (including axes) or surfaces are completely orthogonal to each other but also a case where the two lines (including axes) or surfaces are inclined by ±5°.

A robot system 100 illustrated in FIG. 1 is a device which is used for holding, transporting, and assembling a target 800, such as an electronic component and electronic equipment.

As illustrated in FIG. 1, the robot system 100 includes a cell 80, a robot 1, a second image capturing portion 4, a first image capturing portion 3, a moving mechanism 7, a conveyor 81, a plurality of work portions 82, and a control device 5.

### Cell

As illustrated in FIG. 1, the cell 80 has a function as a housing. The cell 80 includes a base portion 801, a plurality of pillars 802 (side portion) provided in a corner portion on an upper surface 804 of the base portion 801, and a ceiling portion 803 provided on the plurality of pillars 802. In addition, a region surrounded by the upper surface 804, the plurality of pillars 802, and the ceiling portion 803 configures a work space S in which the robot 1 works. In the work space S, the robot 1, the second image capturing portion 4, the first image capturing portion 3, the moving mechanism 7, the conveyor 81, and the plurality of work portions 82 are installed. In addition, although not being illustrated, the cell 80 is movable and is configured to easily perform relocation. In addition, the configuration of the cell 80 may be a configuration having a function as the housing, and is not limited to that illustrated in the drawing.

### Robot

As illustrated in FIG. 1, the robot 1 is attached to the ceiling portion 803. As illustrated in FIG. 3, the robot 1 is a so-called selective compliance assembly robot arm robot (SCARA robot), and includes the base 110 and a robot arm 10 (movable portion) connected to the base 110. The robot arm 10 includes a first arm 101 (arm), a second arm 102 (arm), a work head 104, and a suction portion 150. In addition, as illustrated in FIGS. 2 and 3, the robot 1 includes a plurality of driving portions 130 which generate power that drives the robot arm 10, and a position sensor 131.

The base 110 illustrated in FIG. 3 is a part at which the robot 1 is attached to the ceiling portion 803. The first arm 101 which can rotate around a first axis J1 (rotation axis) along the vertical direction with respect to the base 110, is linked to a lower end portion of the base 110. In addition, the second arm 102 which can rotate around a second axis J2 (rotation axis) along the vertical direction with respect to the first arm 101, is linked to a tip end portion of the first arm 101. In addition, in the second arm 102, the work head 104 is disposed. The work head 104 has a splicing shaft 103 (arm) inserted into a splicing nut and a ball screw nut (both are not illustrated) which are coaxially disposed in the tip end portion of the second arm 102. The splicing shaft 103 can rotate around a third axis J3 thereof and can move (be raised and lowered) in the upward-and-downward direction, with respect to the second arm 102.

As illustrated in FIG. 3, in the tip end portion (lower end portion) of the splicing shaft 103, as an end effector, the suction portion 150 including a suction pad that can suction and hold the target 800 or the like illustrated in FIG. 1, is attached to be attachable and detachable. In addition, in the embodiment, the suction portion 150 is used as the end effector, but as the end effector, a similar configuration may be employed as long as the end effector has a function of performing the work (holding the target member, or the like) with respect to each of the targets.

In addition, on the design, the suction portion 150 is attached such that the center axis of the suction portion 150 is identical to the third axis J3 of the splicing shaft 103. Therefore, the suction portion 150 rotates in accordance with the rotation of the splicing shaft 103. Here, as illustrated in FIG. 3, the tip end center of the suction portion 150 is referred to as a tool center point TCP.

In addition, in the tip end portion of the robot arm 10, a jig 6 having a marker 61 used in calibration which will be described later is attached to be attachable and detachable. In addition, the jig 6 will be described when describing the calibration which will be described later.

In addition, as illustrated in FIG. 3, in the base 110, the driving portion 130 which drives (rotates) the first arm 101 is installed. In addition, similarly, in the first arm 101, the driving portion 130 which drives the second arm 102 is provided, and in the work head 104, the driving portion 130 which drives the splicing shaft 103 is installed. In other words, the robot 1 includes three driving portions 130. The driving portion 130 has a motor (not illustrated) which generates a driving force and a decelerator (not illustrated) which decelerates the driving force of the motor. As a motor included in the driving portion 130, a servo motor, such as an AC servo motor or a DC servo motor, can be used. As the decelerator, for example, a planet gear type decelerator or a wave gear device can be used. In addition, in each of the driving portions 130, the position sensor 131 (angle sensor) which detects a rotation angle of the rotation axis of the motor or the decelerator is provided (refer to FIGS. 2 and 3).

In addition, each of the driving portions 130 is electrically connected to a motor driver 120 embedded in the base 110 illustrated in FIG. 3. Each of the driving portions 130 is controlled by the control device 5 via the motor driver 120.

In the robot 1 having such a configuration, as illustrated in FIG. 3, a three-dimensional rectangular coordinate system which is orthogonal to an xr axis and a yr axis that are respectively parallel to the horizontal direction, and the horizontal direction, and which is determined by a zr axis of which a vertically upward orientation is regarded as a positive direction, is set as a base coordinate system which regards the base 110 of the robot 1 as a reference. In the embodiment, the base coordinate system regards the center point of the lower end surface of the base 110 as an original point. A translational component with respect to the xr axis is referred to as “component xr”, a translational component with respect to the yr axis is referred to as “component yr”, a translational component with respect to the zr axis is referred to as “component zr”, a rotational component around a zr axis is referred to as “component ur”, a rotational component around the yr axis is referred to as “component vr”, and a rotational component around the xr axis is referred to as “component wr”. The unit of lengths (sizes) of the component xr, the component yr, and the component zr is “mm”, and the unit of angles (sizes) of the component ur, the component vr, and the component wr is “°”.

In addition, in the robot 1, a tip end coordinate system which regards the tip end portion of the suction portion 150 as a reference is set. The tip end coordinate system is a three-dimensional rectangular coordinate system determined by an xa axis, a ya axis, and a za axis which are orthogonal to each other. In the embodiment, the tip end coordinate system regards the tool center point TCP as an original point. In addition, a state where the calibration between the base coordinate system and the tip end coordinate system has been finished, and the coordinates of the tip end coordinate system which regards the base coordinate system as a reference can be calculated, is achieved. In addition, a translational component with respect to the xa axis is referred to as “component xa”, a translational component with respect to the ya axis is referred to as “component ya”, a translational component with respect to the za axis is referred to as “component za”, a rotational component around the za axis is referred to as “component ua”, a rotational component around a ya axis is referred to as “component va”, and a rotational component around the xa axis is referred to as “component wa”. The unit of lengths (sizes) of the component xa, the component ya, and the component za is “mm”, and the unit of angles (sizes) of the component ua, the component va, and the component wa is “°”.

Above, the configuration of the robot 1 is briefly described. In the robot 1, as described above, the base 110 is attached to the ceiling portion 803, and the robot arm 10 is positioned further at a vertically lower part than the base 110 (refer to FIG. 1). Accordingly, it is possible to particularly improve workability of the robot 1 in a vertically lower region with respect to the robot 1.

In addition, although not being illustrated, the robot 1 may include, for example, a force detection portion configured of a force sensor (for example, 6-axis force sensor) that detects a force (including a moment) applied to the suction portion 150.

### Second Image Capturing Portion

As illustrated in FIG. 4, the second image capturing portion 4 is fixed to the upper surface 804 of the base portion 801 included in the cell 80. The second image capturing portion 4 has an image capturing function and is installed to be capable of capturing an image of the upper part in the vertical direction.

The second image capturing portion 4 includes, for example, an image capturing device 41 configured of a charge coupled device (CCD) image sensor including a plurality of pixels, a lens 42 (optical system) , and a coaxial episcopic illumination 43. The second image capturing portion 4 forms an image on a light receiving surface (sensor surface) of the image capturing device 41 by the lens 42 by the light reflected by an image capturing target, converts the light into an electric signal, and outputs the electric signal to the control device 5. Here, the light receiving surface is a surface of the image capturing device 41, and is a surface on which the light forms the image. In addition, in the embodiment, as an illumination, not being limited to the coaxial episcopic illumination 43, for example, a transmitted illumination or the like may be employed. In addition, on the design, the second image capturing portion 4 is provided such that an optical axis A4 (optical axis of the lens 42) thereof is along the vertical direction.

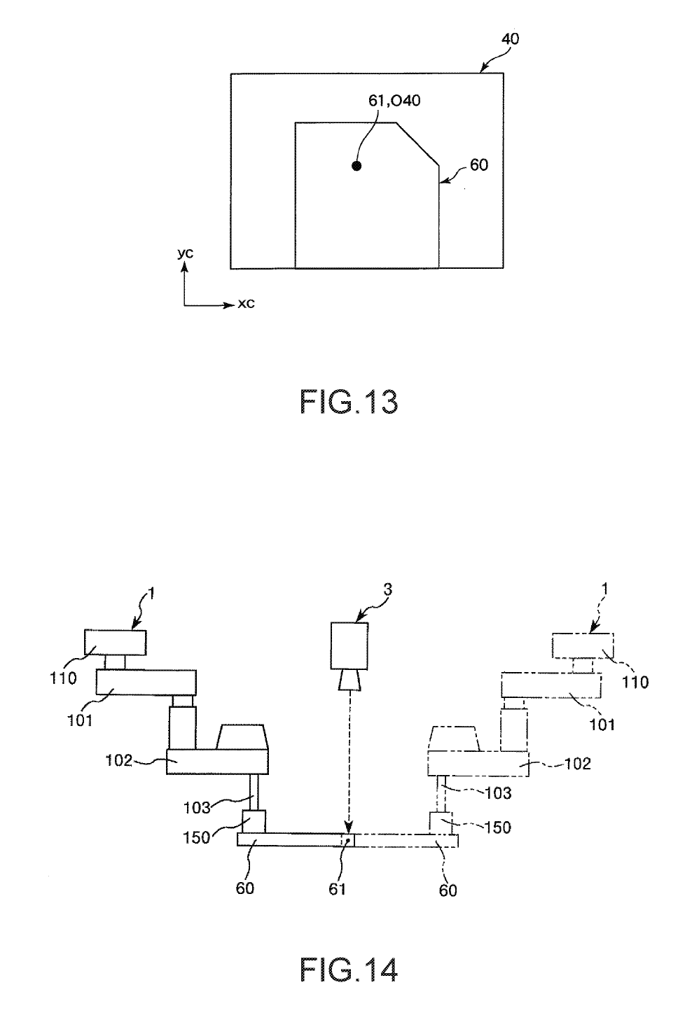

The second image capturing portion 4 sets a two-dimensional rectangular coordinate system determined by an xc axis and a yc axis which are respectively parallel to an in-plane direction of a second captured image 40, as an image coordinate system (coordinate system of the second captured image 40 output from the second image capturing portion 4) of the second image capturing portion 4 (refer to FIG. 13). In addition, a translational component with respect to the xc axis is referred to as “component xc”, a translational component with respect to the yc axis is “component yc”, and a rotational component around a normal line of an xc-yc plane is referred to as “component uc”. The unit of lengths (sizes) of the component xc and the component yc is “pixel”, and the unit of angle (size) of the component uc is “°”. In addition, the image coordinate system of the second image capturing portion 4 is a two-dimensional rectangular coordinate system obtained by adding optical characteristics (focal length, distortion, or the like) of the lens 42, and the number of pixels and the size of the image capturing device 41, and by nonlinearly converting the three-dimensional coordinate system projected in a camera viewing field of the second image capturing portion 4.

### First Image Capturing Portion

As illustrated in FIG. 4, the first image capturing portion 3 is attached to the moving mechanism 7. The first image capturing portion 3 has an image capturing function, and is installed to be capable of capturing an image of a lower part in the vertical direction.

The first image capturing portion 3 includes, for example, an image capturing device 31 configured of the CCD image sensor including a plurality of pixels, a lens 32 (optical system), and a coaxial episcopic illumination 33. The first image capturing portion 3 forms an image on a light receiving surface (sensor surface) of the image capturing device 31 by the lens 32 by the light reflected by an image capturing target, converts the light into an electric signal, and outputs the electric signal to the control device 5. Here, the light receiving surface is a surface of the image capturing device 31, and is a surface on which the light forms the image. In addition, in the embodiment, as an illumination, not being limited to the coaxial episcopic illumination 33, for example, a transmitted illumination or the like may be employed. In addition, on the design, the first image capturing portion 3 is provided such that an optical axis A3 (optical axis of the lens 32) thereof is along the vertical direction.

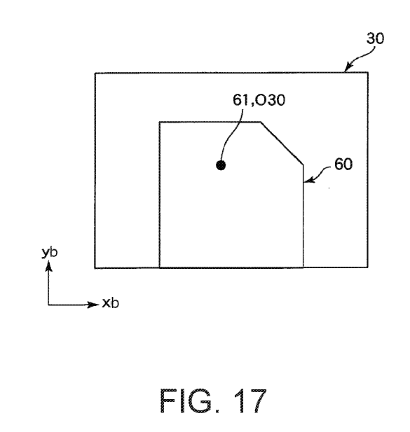

The first image capturing portion 3 sets a two-dimensional rectangular coordinate system determined by an xb axis and a yb axis which are respectively parallel to an in-plane direction of a first captured image 30, as an image coordinate system (coordinate system of the first captured image 30 output from the first image capturing portion 3) of the first image capturing portion 3 (refer to FIG. 17). In addition, a translational component with respect to the xb axis is referred to as “component xb”, a translational component with respect to the yb axis is “component yb”, and a rotational component around a normal line of an xb-yb plane is referred to as “component ub”. The unit of lengths (sizes) of the component xb and the component yb is “pixel”, and the unit of angle (size) of the component ub is “°”. In addition, the image coordinate system of the first image capturing portion 3 is a two-dimensional rectangular coordinate system obtained by adding optical characteristics (focal length, distortion, or the like) of the lens 32, and the number of pixels and the size of the image capturing device 31, and by nonlinearly converting the three-dimensional rectangular coordinate system projected in a camera viewing field of the first image capturing portion 3.

### Moving Mechanism

As illustrated in FIGS. 1 and 4, the moving mechanism 7 is attached to the pillar 802 of the cell 80. As illustrated in FIG. 5, the moving mechanism 7 has a function of moving the first image capturing portion 3, and can reciprocally move the first image capturing portion 3 to three orthogonal axes (three directions illustrated by arrows a11, a12, and a13 in FIG. 5) including an X axis, a Y axis, and a Z axis. In other words, the moving mechanism 7 can move the first image capturing portion 3 in a horizontal plane and along the vertical direction. In addition, the moving mechanism 7 may be capable of moving the first image capturing portion 3, and the moving direction of the first image capturing portion 3 by the moving mechanism 7 is arbitrary not being limited to the three orthogonal axes. For example, a configuration in which the movement only in one direction is possible may be employed.

Although not being illustrated, the moving mechanism 7 includes a power source which generates power for moving the first image capturing portion 3, a power transmission mechanism which transmits the power of the driving source to the first image capturing portion 3, a support member which is connected to the power transmission mechanism and supports the first image capturing portion 3, and a rail which guides the movement of the support member along a predetermined moving direction based on the power transmitted to the power transmission mechanism. Examples of the driving source include a motor, such as a servo motor or a linear motor, a hydraulic cylinder, and air pressure cylinder. As the power transmission mechanism, for example, a mechanism including a combination of a belt, a gear, a rack, and a pinion, and a mechanism including a combination of a ball screw and a ball nut, may be used.

### Conveyor

As illustrated in FIG. 1, the conveyor 81 is installed on the upper surface 804 of the base portion 801 included in the cell 80, and is positioned below the moving mechanism 7. In the embodiment, the target 800 is mounted on the conveyor 81, and the conveyor 81 has a function of transporting the target 800 along the Y axis direction. In addition, a transport direction of the conveyor 81 is not limited thereto, and is arbitrary. In addition, as the conveyor 81 is provided below the moving mechanism 7, the target 800 transported by the conveyor 81 can be captured by the first image capturing portion 3.

In addition, as a specific configuration of the conveyor 81, any configuration may be employed as long as the target 800 can be transported, and for example, a belt conveyor, a roller conveyor, and a chain conveyor, may be used.

### Work Portion

As illustrated in FIG. 1, the plurality of work portions 82 are installed on the upper surface 804 of the base portion 801 included in the cell 80. One work portion 82 is provided on a +X axis side of the cell 80, and other work portions 82 are provided on a −Y axis side of the cell 80. The work portions 82 are configured of, for example, a work base, and the robot 1 performs various types of work, such as packing with respect to the target 800 or assembly of the target 800 in the work portion 82. In addition, the work portion 82 may have a function, for example, as a supply portion which supplies the target 800, or as an inspection portion which inspects the target 800.

### Control Device

The control device 5 illustrated in FIG. 1 controls driving (operation) of each portion of the robot 1, the first image capturing portion 3, and the second image capturing portion 4. The control device 5 is provided in the base portion 801 of the cell 80. The control device 5 can be configured of a personal computer (PC) in which, for example, a processor like a central processing unit (CPU), a read only memory (ROM), and a random access memory (RAM) are embedded. In addition, the control device 5 may be connected to each of the robot 1, the first image capturing portion 3, and the second image capturing portion 4 by any of wired communication and wireless communication. In addition, as illustrated in FIG. 2, a display device 83 having a monitor (not illustrated), such as a display, and an input device 84 including, for example, a mouse or a keyboard, are connected to the control device 5.

Hereinafter, each function (functional portion) included in the control device 5 will be described.

As illustrated in FIG. 2, the control device 5 includes a display control portion 51, an input control portion 52, a control portion 53 (robot control portion), an input/output portion (obtaining portion) 54, and a storage portion 55.

The display control portion 51 is configured of, for example, a graphic controller, and is connected to the display device 83. The display control portion 51 has a function of displaying various screens (for example, a screen for operation) in the monitor of the display device 83. In addition, the input control portion 52 is connected to the input device 84, and has a function of receiving an input from the input device 84.

The control portion 53 has a function of controlling the driving of the robot 1, the operation of the first image capturing portion 3, and the operation of the second image capturing portion 4, and has a function of performing processing, such as various types of computing and determination. The control portion 53 is configured of, for example, a processor like a CPU, and each function of the control portion 53 can be realized by executing various programs stored in the storage portion 55 by the CPU.

Specifically, the control portion 53 controls the driving of each of the driving portions 130, and drives or stops the robot arm 10. For example, the control portion 53 derives a target value of the motor (not illustrated) included in each of the driving portions 130 for moving the suction portion 150 to a target position based on information output from the position sensor 131 provided in each of the driving portions 130. In addition, the control portion 53 performs processing, such as various types of computing or various types of determination, based on the information from the position sensor 131, the first image capturing portion 3, and the second image capturing portion 4, which is obtained by the input/output portion 54. For example, the control portion 53 computes the coordinates (components xb, yb, and ub: position and posture) of the image capturing target in a first image coordinate system based on the first captured image 30 (refer to FIG. 17). Similarly, the control portion 53 computes the coordinates (components xc, yc, and uc: position and posture) of the image capturing target in a second image coordinate system based on the second captured image 40 (refer to FIG. 13) . In addition, for example, the control portion 53 acquires a correction parameter for converting coordinates (first image coordinates) in the first image coordinate system of the first image capturing portion 3 into coordinates (robot coordinates) in the tip end coordinate system of the robot 1 and coordinates (base coordinates) in the base coordinate system of the robot 1. In addition, similarly, the control portion 53 acquires a correction parameter for converting coordinates (second image coordinates) in the second image coordinate system of the second image capturing portion 4 into coordinates (robot coordinates) in the tip end coordinate system of the robot 1 and coordinates (base coordinates) in the base coordinate system of the robot 1. In addition, in the embodiment, the tip end coordinates of the robot 1 is regarded as “robot coordinates”, but the base coordinates may be regarded as “robot coordinates”.

In addition, in the embodiment, the control portion 53 does not have a function of controlling the driving of the moving mechanism 7, and the driving of the moving mechanism 7 is controlled by a moving mechanism control device configured of the PC or the like which is not illustrated, but instead of the moving mechanism control device, the control portion 53 may have a function of controlling the driving of the moving mechanism 7. In addition, in the embodiment, the control portion 53 can control the operations of the first image capturing portion 3 and the second image capturing portion 4, but the operations may be controlled by an image capturing portion control device configured of the PC or the like which is not illustrated. The control device 5 may be capable of obtaining the information at least from the first image capturing portion 3 and the second image capturing portion 4.

The input/output portion 54 (obtaining portion) is configured of an interface circuit or the like, and has a function of switching the information with the robot 1, the first image capturing portion 3, and the second image capturing portion 4. For example, the input/output portion 54 has a function of obtaining a rotation angle of a rotation axis of the motor or the decelerator included in each of the driving portions 130 of the robot 1, and information of the first captured image 30 and the second captured image 40. In addition, the input/output portion 54 has a function of obtaining the information of moving amount (moving amount of the first image capturing portion 3) of the moving mechanism 7. In addition, for example, the input/output portion 54 outputs the target value of the motor derived from the control portion 53 to the robot 1.

The storage portion 55 is configured of, for example, the RAM and the ROM, and stores a program for performing various types of processing by the control device 5 or various types of data. For example, in the storage portion 55, a program for executing the calibration or a moving amount or the like of each portion of the robot arm 10 for positioning the tool center point TCP of the robot arm 10 at a target location, is stored. In addition, the storage portion 55 is not limited to a portion (the RAM or the ROM) embedded in the control device 5, and may be configured to include a so-called external storage device (not illustrated).

In addition, as described above, the display device 83 includes the monitor (not illustrated) , such as a display, and for example, have a function of displaying the first captured image 30 and the second captured image 40. Therefore, an operator can confirm the work or the like of the first captured image 30 and the second captured image 40, or the robot 1, via the display device 83. In addition, as described above, the input device 84 is configured of, for example, a mouse or a keyboard. Therefore, the operator can give an instruction, such as various types of processing, with respect to the control device 5 by operating the input device 84. In addition, instead of the display device 83 and the input device 84, a display input device (not illustrated) including both the display device 83 and the input device 84 may be used. As the display input device, for example, a touch panel or the like can be used.

Above, a basic configuration of the robot system 100 is briefly described. In the robot system, the work is performed in the robot 1 based on the first captured image 30 or the second captured image 40. Therefore, it is necessary to acquire a transformation matrix expression (correction parameter) which converts the first image coordinates (xb, yb, and ub) into the robot coordinates (xa, ya, and ua), and to acquire a transformation matrix expression (correction parameter) which converts the second image coordinates (xc, yc, and uc) into the robot coordinates (xa, ya, and ua). In other words, calibration (first corresponding) between the first image capturing portion 3 and the robot 1 and calibration (second corresponding) between the second image capturing portion 4 and the robot 1, are necessary. The calibration is automatically performed by the control device 5 based on the program for executing the calibration in accordance with the instruction by the operator.

Hereinafter, the calibration (various types of setting and execution for the calibration) will be described.

### Calibration

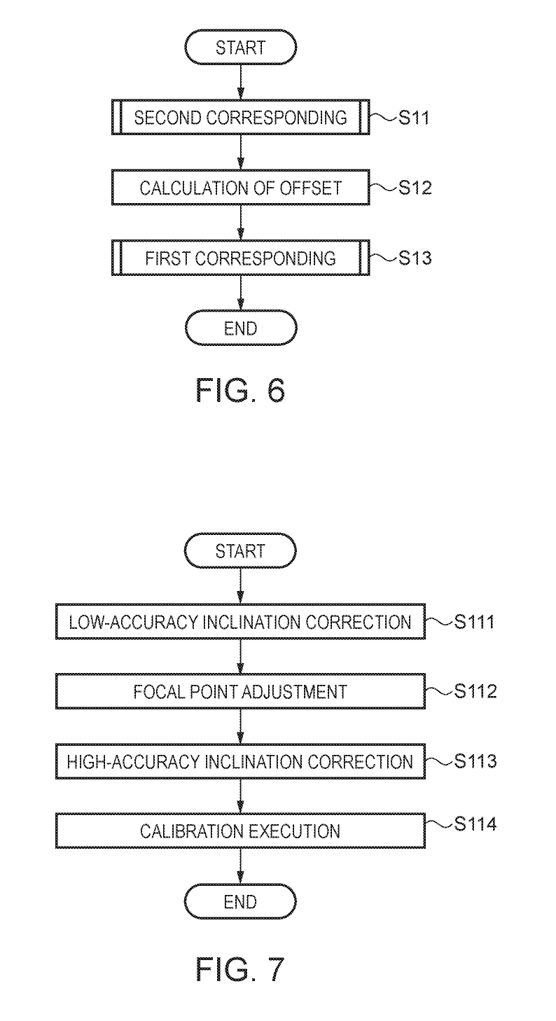

FIG. 6 is a flowchart illustrating a flow of the calibration by the robot system illustrated in FIG. 1.

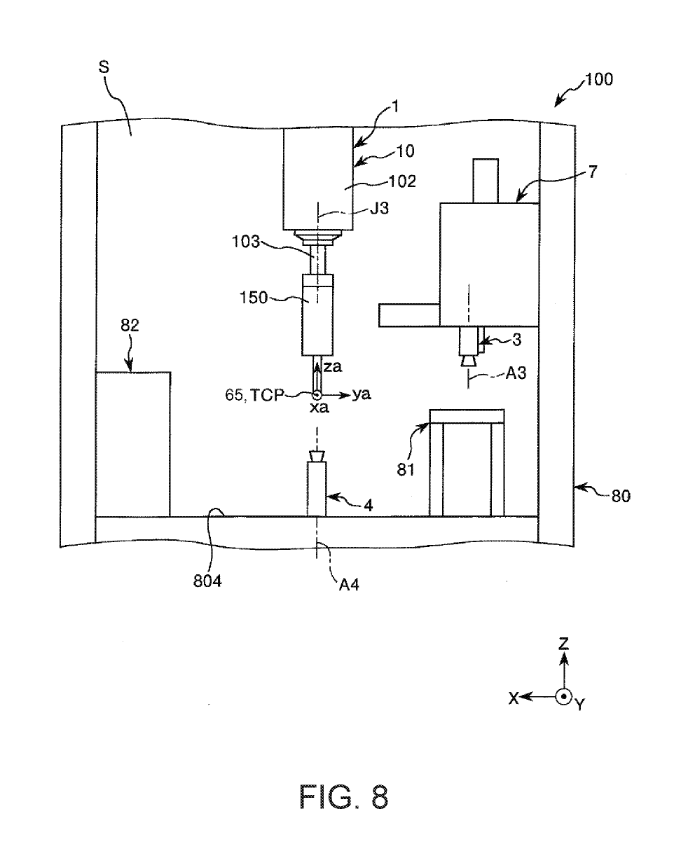

Before performing the calibration, the operator drives the robot arm 10, for example, by a so-called jog feeding (by a manual instruction via the display device 83 using the input device 84), and moves the robot arm 10 to a position at which the tool center point TCP can be captured by the second image capturing portion 4 (refer to FIG. 8). After this, as the operator performs the instruction of start with respect to the control device 5, the calibration is started by the control device 5. After this, under the control of the control device 5, it is possible to automatically perform the calibration. Therefore, it is possible to perform the calibration only by a simple operation or work of the operator.

In addition, before performing the calibration, the control device 5 stores the information or the like of the number of pixels of the first image capturing portion 3 and the second image capturing portion 4, sets a speed and an acceleration (more specifically, for example, a moving speed and a moving acceleration of the suction portion 150) of the robot 1, and sets a local plane (work plane).

### Second Corresponding (FIG. 6: Step S11)

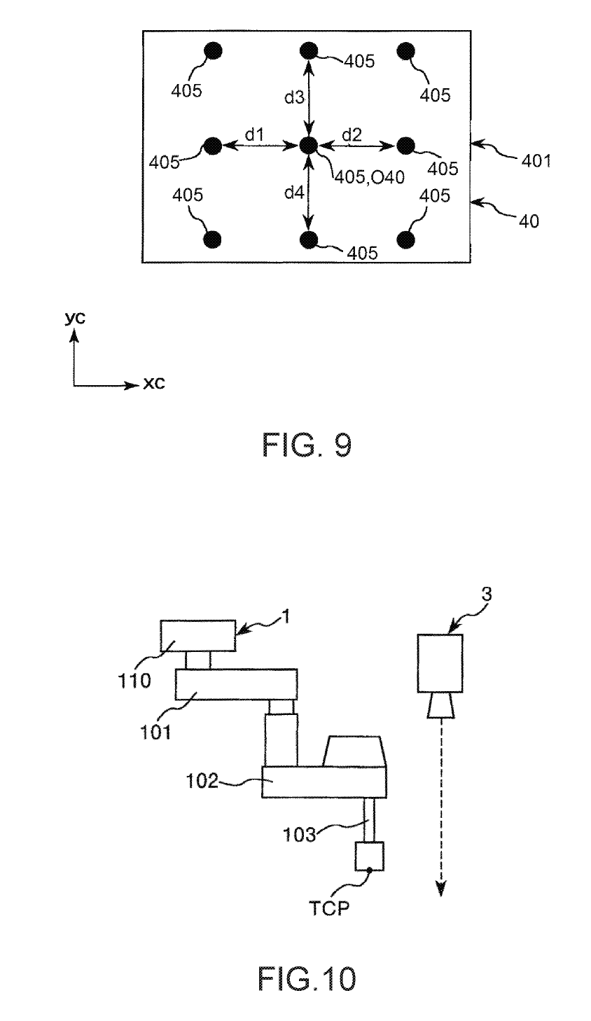

FIG. 7 is a flowchart for describing step S11 illustrated in FIG. 6. FIG. 8 is a view illustrating an example of a state of the robot in step S11 illustrated in FIG. 6. FIG. 9 is a view illustrating a plurality of reference points used in step S11 illustrated in FIG. 6.

First, the control portion 53 performs the corresponding (second corresponding) between the second image coordinate system and the robot coordinate system. Accordingly, as described above, since a state where the corresponding between the robot coordinate system and the base coordinate system has been finished is achieved, it is possible to perform the corresponding between the second image coordinate system and the base coordinate system.

As illustrated in FIG. 7, in the second corresponding, for example, low-accuracy inclination correction, focal point adjustment, high-accuracy inclination correction, and calibration execution are performed.

In addition, when performing the second corresponding, for example, a circular marker 65 or the like which can be captured by the second image capturing portion 4 is provided at the tool center point TCP (refer to FIG. 8). In addition, the shape of the marker 65 is not limited to the circle, and may be a shape other than a circular shape or may be a character or the like. In addition, step S11 may be performed in a state where the jig 6 is mounted at the tip end of the robot arm 10 when the tool center point TCP or the marker 65 provided there can be captured by the second image capturing portion 4. In addition, a calibration board other than the jig 6 may be used.

### Low-accuracy Inclination Correction (FIG. 7: Step S111)

First, the control portion 53 drives the robot arm 10, and moves the marker 65 positioned at the tool center point TCP at each of a plurality of arbitrary reference points 405 (virtual target points) arranged, for example, in a shape of a lattice, in a virtual reference plane 401 illustrated in FIG. 9. At this time, every time when the marker 65 is positioned with respect to one reference point 405, the control portion 53 captures an image of the marker 65 by the second image capturing portion 4, and the input/output portion 54 obtains the second captured image 40 obtained by capturing an image of the marker 65. In addition, at this time, the storage portion 55 stores the second image coordinates and the robot coordinates at each of the reference points 405. In addition, the control portion 53 acquires the correction parameter (coordinate transformation matrix) for converting the second image coordinates into the robot coordinates based on the second image coordinates (components xc and yc) and the robot coordinates (components xa and ya) of the tool center point TCP at each of the reference points 405 based on the plurality of second captured images 40. In addition, the control portion acquires the correction parameter (coordinate transformation matrix) for converting the second image coordinates into the base coordinates based on the acquired correction parameter.

In addition, the number of reference points 405 may be at least three or more, the number is arbitrary, but the accuracy of the calibration is improved as the number of reference points 405 increases. In the embodiment, as illustrated in FIG. 9, the number of reference points 405 is nine. In addition, the reference plane 401 is a virtual surface orthogonal to the optical axis A4 of the second image capturing portion 4. In addition, the reference plane 401 has a plane coordinate system which is set based on the tip end coordinate system and in which the original point is the marker 65. In addition, the plurality of reference points 405 are in the second captured image 40 (in an image capturing region), the reference point 405 positioned at the center in FIG. 9 is identical to a center 040 of the second captured image 40. In addition, as described above, the marker 65 is positioned with respect to each of the reference points 405, but this may be performed, for example, by a so-called jog feeding, or may be performed by outputting the target value (the robot coordinates or the base coordinates) set in advance.

In addition, in the embodiment, in order to further improve the accuracy of the calibration, steps s112, 5113, and S114 are performed (refer to FIG. 7) . Therefore, as necessary, the following steps S112, S113, and S114 may be omitted.

### Focal Point Adjustment (FIG. 7: Step S112)

Next, the control portion 53 drives the robot arm 10 (moves the splicing shaft 103 vertically) to move the tool center point TCP in the za direction, and searches for a location at which an outline of the marker 65 projected to the second captured image 40 becomes the clearest (refer to FIG. 8). In addition, the storage portion 55 stores the location at which the outline of the marker 65 becomes the clearest based on the search result, as a state (focusing state) where the reference plane 401 is focused by the second image capturing portion 4. In other words, the storage portion 55 sets (updates) the new reference plane 401 which is orthogonal to the optical axis A4 and is in a focusing state.

### High-accuracy Inclination Correction (FIG. 7: Step S113)

Here, the reference plane 401 acquired in step S112 is perpendicular to the optical axis A4, but there is a case where the reference plane 401 is inclined from a state of being perpendicular to the optical axis A4 due to an error of a position of the marker 65 installed at the tool center point TCP or an installation position of the second image capturing portion 4. Here, in step S113, the control portion 53 sets (updates) the new reference plane 401 which is in a more completely perpendicular state.

Specifically, first, the control portion 53 acquires an inclination index H1 (components va and wa) of the current reference plane 401. Next, the control portion 53 is rotated around the axis along the xb direction such that a difference between a distance dl between the reference point 405 positioned at the center in FIG. 9 and the reference point 405 positioned on the left side, and a distance d2 between the reference point 405 positioned at the center and the reference point 405 positioned on the right side is within a predetermined threshold value range R1. Similarly, the control portion 53 is rotated around the axis along the yb direction such that a difference between a distance d3 between the reference point 405 positioned at the center and the reference point 405 positioned on the upper side, and a distance d4 between the reference point 405 positioned at the center and the reference point 405 positioned on the lower side is within a predetermined threshold value range R2. Here, the predetermined threshold value ranges R1 and R2 are respectively preferably 0 (zero), and accordingly, the threshold value ranges R1 and R2 are respectively preferably, for example, ±10.

Next, the control portion 53 acquires an inclination index H2 (components va and wa) of the reference plane 401 within the predetermined threshold value range R1. In addition, the control portion 53 acquires an inclination index H3 (components va and wa) of the reference plane 401 within a predetermined threshold value range R2. Next, the control portion 53 acquires an inclination correction amount (Δva and Δwa) with respect to the reference plane 401 acquired in step 5112 based on the inclination indexes H1, H2, and H3. In addition, the control portion 53 sets (updates) the reference plane 401 acquired in step S112 and the new reference plane 401 based on the inclination correction amount (Δva and Δwa). In addition, the control portion 53 sets the target value (the robot coordinates or the base coordinates) at the new reference point 405 based on the new reference plane 401.

By performing the high-accuracy inclination correction (step S113), it is possible to further improve the accuracy of the calibration.

### Calibration Execution (FIG. 7: Step S114)

The control portion 53 outputs the target value acquired in step 5113 with respect to the robot 1, drives the robot arm 10, and moves the marker 65 to each of the new reference points 405. At this time, every time when positioning the marker 65 with respect to one reference point 405, the control portion 53 captures the image of the marker 65 by the second image capturing portion 4, and the storage portion 55 stores the second image coordinates and the robot coordinates at each of the reference points 405. In addition, the control portion 53 acquires (updates) the correction parameter for converting the second image coordinates into the robot coordinates based on the second image coordinates (components xc and yc) and the robot coordinates (components xa and ya) of the tool center point TCP at each of the reference points 405 based on the plurality of second captured images 40. In addition, the correction parameter for converting the second image coordinates into the base coordinates is acquired based on the acquired correction parameter, is acquired (updated).

As described above, the calibration (second corresponding) between the second image capturing portion 4 and the robot 1 is finished. Accordingly, it is possible to acquire the position at the robot coordinates of the captured image projected to the second captured image 40. In addition, as described above, in the embodiment, by performing the focal point adjustment (step S112) or the high-accuracy inclination correction (step S113) for acquiring the inclination correction amount of the reference plane 401, it is possible to particularly improve the positional accuracy at the robot coordinates of the image capturing target projected to the second captured image 40.

### Calculation of Offset (FIG. 6: Step S12)

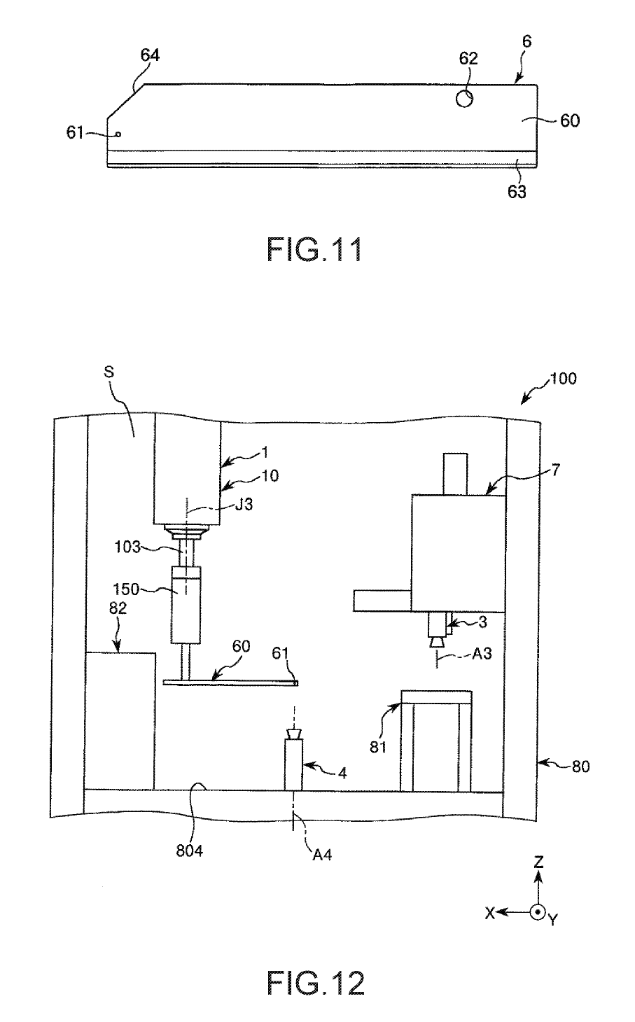

FIG. 10 is a schematic view of the robot for describing step S12 illustrated in FIG. 6. FIG. 11 is a plan view of the jig attached to the robot arm included in the robot illustrated in FIG. 3. FIG. 12 is a view illustrating one example of a state of the robot in step S12 illustrated in FIG. 6. FIG. 13 is a view illustrating one example of the second captured image in step S12 illustrated in FIG. 6. FIG. 14 is a reference view for describing step S12 illustrated in FIG. 6.

Next, the control portion 53 attaches the jig 6 to the tip end of the robot arm 10, and calculates (measures) the robot coordinates of the marker 61 of the jig 6 by using the second image capturing portion 4 which has finished the calibration, and accordingly, the shift, that is, the offset, of the position of the marker 61 with respect to the tool center point TCP is acquired.

Here, similar to the above-described second corresponding (step S11), in the corresponding (first corresponding) between the first image coordinate system and the robot coordinate system in step S13 which will be described later, originally, it is necessary to capture the tool center point TCP by the first image capturing portion 3. However, as illustrated in FIG. 10, in the first image capturing portion 3, it is not possible to capture the tool center point TCP. This is because the tool center point TCP is positioned at the vertically lower part of the robot 1, the first image capturing portion 3 is configured to capture the vertically lower part, and it is not possible to position the tool center point TCP within the viewing field of the first image capturing portion 3. Here, by using the jig 6 provided with the marker 61 in FIG. 11, the marker 61 is captured instead of the tool center point TCP by the first image capturing portion 3 (refer to FIG. 12). Accordingly, in step S13 which will be described later, the first corresponding is performed based on the robot coordinates of the marker 61. Therefore, in step S12 before step S13, the robot coordinates of the marker 61 is calculated.

Hereinafter, the jig 6 will be described in detail before describing step S12. The jig 6 illustrated in FIG. 11 can be attached to the tip end portion (tip end portion of the suction portion 150 in the embodiment) of the robot arm 10 (refer to FIG. 3). The jig 6 is configured of a long thin plate formed by using a metal material, such as SUS304. In addition, the jig 6 has a length by which the jig 6 protrudes to the outer side from the splicing shaft 103 when viewed from the direction along the axis parallel to the third axis J3 in a state of being attached to the tip end portion of the robot arm 10 (refer to FIG. 3).

As illustrated in FIG. 11, the jig 6 includes a plate-like main body portion 60, an attaching portion 62 used for attaching the jig 6 to the tip end portion of the robot arm 10, the marker 61, a beam 63, and a cutout 64.

In the embodiment, the attaching portion 62 is provided in a right end portion (one end portion) in FIG. 11 of the main body portion 60. The attaching portion 62 is configured of a hole through which both main surfaces (two plate surfaces) of the main body portion 60 penetrate. In the hole, for example, as the tip end of the suction portion 150 penetrates, it is possible to attach the jig 6 to the tip end portion of the robot arm 10. In addition, the “attaching portion” may have any configuration as long as it is possible to use the attaching portion for attaching the jig 6 to the tip end portion of the robot arm 10.

The marker 61 is provided in the left end portion (end portion on the side opposite to the attaching portion 62) in FIG. 11 of the main body portion 60. The marker 61 configures a transmitting portion having optical transmission properties (properties by which the light is transmitted during the image capturing), and is configured of a hole through which the both surfaces (plate surfaces) of the main body portion 60 penetrate in the embodiment. In addition, the marker 61 may be configured of a member having optical transmission properties. In addition, in a case where the marker 61 does not configure the transmitting portion, the marker 61 may be configured of, for example, markers (two markers) which are respectively given to both surfaces of the main body portion 60. In this case, the two markers may overlap each other when viewed from the direction along the thickness direction of the jig 6.

The beam 63 is provided along the longitudinal direction of the main body portion 60, and is provided along the edge on the lower side in FIG. 11 of the main body portion 60 (refer to FIG. 5). As the jig 6 is provided with the beam 63, it is possible to improve rigidity of the main body portion 60, and accordingly, it is possible to reduce the curve of the main body portion 60. In addition, by providing the beam 63, it is possible to make the thickness of the main body portion 60 relatively thin while ensuring rigidity of the jig 6. Therefore, it is possible to reduce a concern that the jig 6 interferes with the peripheral device even when the jig 6 moves in accordance with the driving of the robot arm 10. In addition, the cutout 64 is provided in the end portion on the side on which the marker 61 of the main body portion 60 is positioned. Accordingly, it is possible to reduce a concern that the end portion on the marker 61 side of the jig 6 interferes with the peripheral device.

At the part excluding the marker 61 of the jig 6 having the configuration, it is preferable that the light absorbing film, such as a black flat coating film, is provided. Accordingly, reflectivity of light is suppressed, and it becomes easier to recognize the outline of the marker 61 by the coaxial episcopic illumination. The optical absorbing film can be formed, for example, by using Raydent processing. In addition, the light absorbing film may not be provided at the entire part excluding the marker 61 of the jig 6, and is provided at least at an outer circumferential portion of the marker 61, and accordingly, the above-described effects can be obtained.

By using the jig 6, step S12 is executed. Hereinafter, step S12 will be described.

First, the control portion 53 drives the robot arm 10 such that the marker 61 is positioned within the viewing field of the second image capturing portion 4 which has finished the calibration (refer to FIG. 12). More specifically, the control portion 53 drives the robot arm 10 such that the marker 61 is projected (positioned) at the center 040 of the second captured image 40 (refer to FIG. 13) . In addition, for example, the driving of the above-described robot arm 10 may be performed, for example, by a so-called jog feeding, or the robot arm 10 may be moved based on the distance (length) on the design between the attaching portion 62 and the marker 61 of the jig 6 and the target value (robot coordinates) acquired from the attaching direction of the jig 6 with respect to the robot arm 10.

In addition, the control portion 53 captures the image of the marker 65 by the second image capturing portion 4 when the marker 61 is positioned at the center 040, and the input/output portion 54 obtains the second captured image 40 obtained by capturing an image of the marker 61 (refer to FIG. 13). Next, the control portion 53 acquires the second image coordinates when the marker 61 is positioned at the center 040 based on the second captured image 40. In addition, the control portion 53 acquires the base coordinates of the marker 61 by using the correction parameter for the second corresponding acquired in step S11 (step S113). In addition, the control portion 53 acquires the distance between the base coordinates of the marker 61 and the base coordinates of the tool center point TCP from the base coordinates of the marker 61 and the base coordinates of the tool center point TCP when the marker 61 is positioned at the center O40. In addition, the storage portion 55 stores the distance as an offset of the marker 61 with respect to the tool center point TCP.

In this manner, by using the second image capturing portion 4 which has finished the calibration, it is possible to acquire the offset of the marker 61 in the first image capturing. Therefore, it is possible to acquire the offset without excessively driving the robot arm 10. For example, as illustrated in FIG. 14, a method for acquiring the offset by moving the tool center point TCP to two locations different from each other and by solving a simultaneous equation in which the distance between the tool center point TCP and the marker 61, the rotation angle of the tool center point TCP around the marker 61, the base coordinates at two locations of the tool center point TCP, and the second image coordinates of the marker 61 are used, can be omitted. In other words, instead of the method for acquiring the offset, it is possible to use calculation of the offset of step S12. Therefore, when acquiring the offset, since there is not a case where the robot arm 10 is excessively driven, it is possible to reduce the interference of the jig 6 with the peripheral device or the like.

In addition, as described above, in the second image capturing portion 4, the coaxial episcopic illumination 43 is used (refer to FIG. 4). In addition, as described above, the jig 6 has a light absorbing film on the surface thereof. In addition, the marker 61 is a transmitting portion having optical transmission properties. Therefore, by capturing the image of the marker 61 and the periphery thereof by the second image capturing portion 4, it is possible to clearly capture the outline of the marker 61 (refer to FIG. 13). As a result, it is possible to improve the image capturing accuracy of the second captured image 40, and to improve the measuring accuracy of the marker 61. As a result, it is possible to further improve the calculation accuracy of the offset. In addition, the second image capturing portion 4 can achieve similar effects even when a transmitted illumination is provided instead of the coaxial episcopic illumination 43.

### First Corresponding (FIG. 6: Step S13)

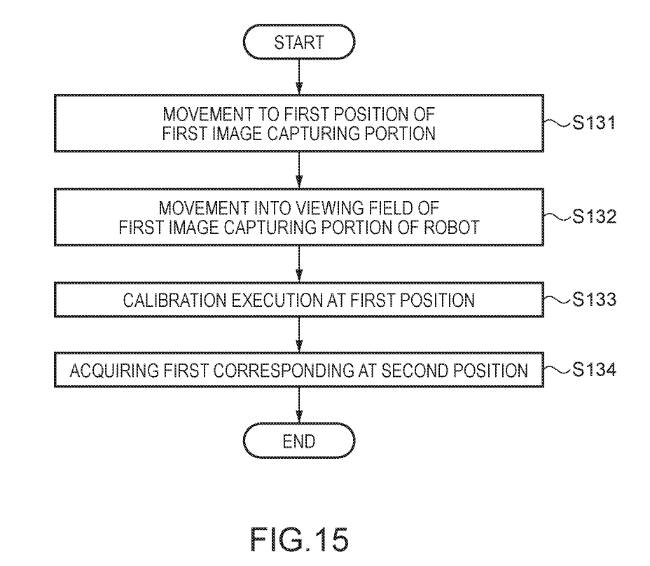

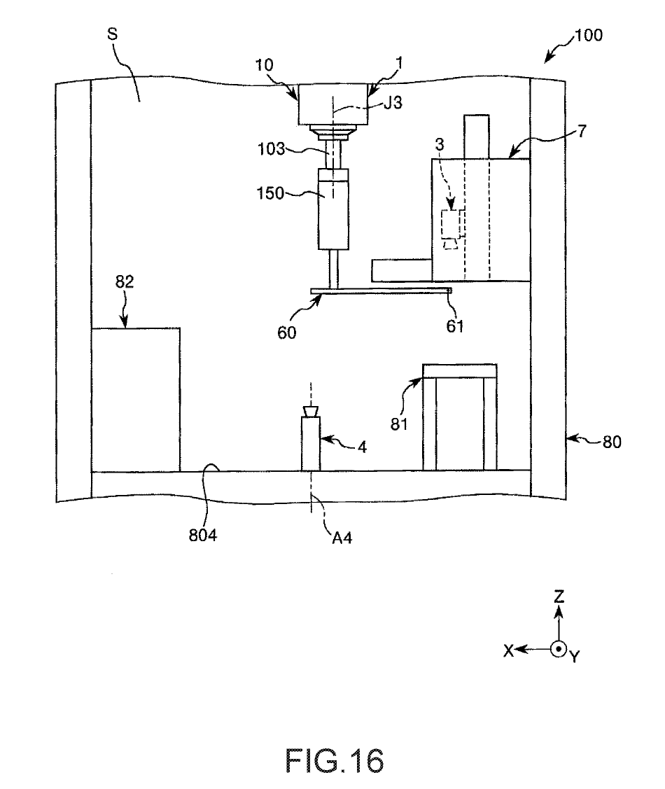

FIG. 15 is a flowchart for describing step S13 illustrated in FIG. 6. FIG. 16 is a view illustrating one example of a state of the robot in step S13 illustrated in FIG. 6. FIG. 17 is a view illustrating one example of a first captured image in step S13 illustrated in FIG. 6.

Next, the control portion 53 performs the corresponding (first corresponding) between the first image coordinate system and the robot coordinate system. Accordingly, as described above, since a state where the corresponding between the robot coordinate system and the base coordinate system has been finished, is achieved, it is possible to perform the corresponding between the first image coordinate system and the base coordinate system. In addition, in the embodiment, as described above, since the first image capturing portion 3 is movable, the control portion 53 performs the first corresponding at a plurality of locations.

Hereinafter, the description will refer to the flowchart illustrated in FIG. 15.

### Movement to First Position of First Image Capturing Portion (FIG. 15: Step S131)

First, when performing the first corresponding, the first image capturing portion 3 is moved to a position (first position) illustrated in FIG. 16 such that the robot 1 does not interfere with the peripheral device when performing the corresponding.

Here, in the embodiment, for example, from the state illustrated in FIG. 4, when the marker 61 is moved in an arrow al direction in FIG. 4 by driving the robot arm for positioning the marker 61 in the viewing field of the first image capturing portion 3, there is a concern that the robot 1 interferes with the peripheral device. As described above, below the work space S of the cell 80, although not being illustrated, wiring or the like or various devices or the like which are connected to the work portion 82 or the conveyor 81 which is a peripheral device, is disposed. Therefore, when the marker 61 is moved in the arrow al direction from the state illustrated in FIG. 4, the jig 6 or the robot 1 is likely to interfere with the peripheral device. Therefore, in the embodiment, the first image capturing portion 3 is moved such that the jig 6 or the robot 1 does not interfere with the peripheral device when performing the first corresponding of the robot 1. For example, as illustrated in FIG. 16, the first image capturing portion 3 is moved in the Z axis direction by the moving mechanism 7, and the first image capturing portion 3 is positioned in the region on the upper side of the work space S. The position of the first image capturing portion 3 after being moved in the Z axis direction by the moving mechanism 7 is set to be “first position”.

In addition, the moving direction of the first image capturing portion 3 may be a direction for the movement in a direction in which the peripheral device is unlikely to be interfered, and is not limited to the Z axis direction. Accordingly, even when the marker 61 is positioned within the viewing field of the first image capturing portion 3, it is possible to avoid interference (collision) of the jig 6 or the robot 1 with the peripheral device or the like.

### Movement Within Viewing Field of First Image Capturing Portion of Robot (FIG. 15: Step S132)

Next, when the movement of the moving mechanism 7 is finished, the control portion 53 drives the robot arm 10 to position the marker 61 of the jig 6 within the viewing field of the first image capturing portion 3 at the first position. More specifically, the control portion 53 drives the robot arm 10 such that the marker 61 is projected (positioned) at a center O30 of the first captured image 30 (refer to FIG. 17).

### Calibration Execution at First Position (FIG. 15: Step S133)

Next, the control portion 53 performs the first corresponding at the first position. Accordingly, at the first position, it is possible to acquire the position at the robot coordinates of the image capturing target projected to the first captured image 30.

In addition, in the first corresponding, similar to the above-described second corresponding (step S11), for example, the low-accuracy inclination correction, the focal point adjustment, the high-accuracy inclination correction, and the calibration execution are performed (refer to FIG. 7). The first corresponding is similar except that the marker 61 is used instead of the tool center point TCP, and thus, the description thereof will be omitted. In addition, as described above, in the embodiment, by performing the focal point adjustment (step S112) or the high-accuracy inclination correction (step S113) for acquiring the inclination correction amount of the reference plane 401, it is possible to particularly improve the positional accuracy at the robot coordinates of the image capturing target projected to the first captured image 30.

Here, as described above, in step S131, since the first image capturing portion 3 is moved in a direction in which the robot 1 is unlikely to interfere with the peripheral device, the interference with the jig 6 can be avoided.

In addition, as described above, in the first corresponding at the first position, since it is not possible to capture the tool center point TCP by the first image capturing portion 3 unlike the second corresponding, the jig 6 is used. In addition, the marker 61 is captured instead of the tool center point TCP. Accordingly, it is possible to perform the first corresponding between the first image coordinate system and the tip end coordinate system by using the marker 61. In addition, in step S12, the offset of the marker 61 is acquired, and thus, by subtracting the offset of the marker 61, the position of the tool center point TCP can be specified. Therefore, even when performing the calibration by using the marker 61, it is possible to perform the first corresponding.

In addition, in the above-described step S12, the marker 61 is captured from the lower surface (one surface) side of the jig 6, but in step S13, the marker 61 is captured from the upper surface (other surface) side of the jig 6. This is because the first image capturing portion 3 can capture the vertically lower part while the second image capturing portion 4 can capture the vertically upper part. In this manner, even in a case where the image capturing directions of the second image capturing portion 4 and the first image capturing portion 3 are opposite to each other, it is possible to grasp the marker 61 or a wall portion (edge portion) that forms the hole of the marker 61 from both main surfaces of the jig 6, and thus, it is possible to appropriately perform the second corresponding at the first position by using the offset acquired in the above-described step S12. In particular, as the marker 61 is configured of a hole, it is possible to reduce the positional shift of the marker on both main surfaces. In addition, this case is preferable since the forming is also easy.

In addition, as described above, even in the first image capturing portion 3, similar to the second image capturing portion 4, the coaxial episcopic illumination 33 is used (refer to FIG. 4). In addition, as described above, the jig 6 has the light absorbing film on the surface thereof. In addition, the marker 61 is a transmitting portion having optical transmission properties. Therefore, by capturing the image of the marker 61 and the periphery thereof by the first image capturing portion 3, it is possible to clearly capture the outline of the marker 61 (refer to FIG. 17). As a result, it is possible to improve the image capturing accuracy of the first captured image 30, and to improve the measuring accuracy of the marker 61. As a result, it is possible to further improve the first corresponding. In addition, the first image capturing portion 3 can achieve similar effects even when the transmitting illumination is provided instead of the coaxial episcopic illumination 33.

### Acquiring First Corresponding at Second Position (FIG. 15: Step S134).

Next, the control portion 53 performs (acquires), for example, the first corresponding at a position (second position) of the first image capturing portion 3 illustrated in FIG. 4, based on the calibration result of the first position. The corresponding at the second position is performed based on the calibration result at the first position and the distance (moving amount by the moving mechanism 7) between the first position and the second position. In other words, the calibration between the first image capturing portion and the robot is performed at the second position. In this manner, practically, even when the calibration is not executed, it is possible to perform the first corresponding at the second position.

Furthermore, similarly, the control portion 53 performs the first corresponding at an arbitrary location different from the first position and the second position. In this manner, practically, even when the calibration is not executed, it is possible to perform the first corresponding at a plurality of locations.

Accordingly, the first corresponding (step S13) is finished.

As described above, the control device 5 which is one example of the control device according to the invention controls the robot 1 including the robot arm 10 that functions as “movable portion” provided with the jig 6 that functions as “tool” including the marker 61. In addition, the control device 5 includes: the input/output portion 54 that functions as “obtaining portion” which obtains the first captured image 30 (image data) obtained by capturing the image of the marker 61 by the movable first image capturing portion 3 that captures an image of the marker 61; and the control portion 53 which performs the first corresponding (step S13) between the coordinate system (first image coordinate system) of the first image capturing portion 3 and the coordinate system (tip end coordinate system) of the robot 1 based on the first captured image 30 obtained by the input/output portion 54 after the first image capturing portion 3 has moved. According to the control device 5, it is possible to perform the first corresponding (calibration) at a location at which the first image capturing portion 3 is moved and does not interfere with the peripheral device or the like. Therefore, since it is possible to perform the first corresponding even in a relatively narrow region, it is possible to reduce the work space S of the robot 1. In addition, since it is possible to perform the first corresponding in a state where the first image capturing portion 3 is stopped after being moved, it is not necessary to consider the moving direction of the first image capturing portion 3. Therefore, the first corresponding between the first image coordinate system and the tip end coordinate system is easy. In addition, by providing the jig 6 including the marker 61, it is possible to perform the first corresponding between the first image coordinate system and the tip end coordinate system by using the marker 61 instead of the tool center point TCP. In addition, the jig 6 has a part that protrudes to the outer side from the splicing shaft 103 when viewed from the direction along the third axis J3. Therefore, even in a case where it is not possible to capture the predetermined part (tool center point TCP in the embodiment) of the robot 1 by the first image capturing portion 3, it is possible to perform the first corresponding by obtaining the first captured image 30 obtained by capturing the image of the marker 61.

In addition, “robot coordinate system” is regarded as the tip end coordinate system in the embodiment, but may be regarded as the base coordinate system of the robot 1, or may be regarded as a coordinate system of a predetermined portion of the robot 1 other than the tip end coordinate system. In addition, “tool” is not limited to the jig 6, and may be other configurations as long as “marker” can be captured by the first image capturing portion 3.

In addition, as described above, the first image capturing portion 3 is provided at a location different from the robot arm 10 that functions as “movable portion”. Accordingly, it is possible to perform the first corresponding in the first image capturing portion 3 provided on the periphery of the robot 1. Therefore, it appropriately performs the work based on the first captured image 30 captured by using the first image capturing portion 3 that has finished the first corresponding, for example, work on the conveyor 81. In addition, as a location different from the robot arm 10, for example, the base 110 or the like may be employed.

In addition, as described above, after the control portion 53 performs the second corresponding (step S11) between the coordinate system (second image coordinate system) of the second image capturing portion 4 obtained by capturing the image of the marker 61 and the coordinate system (tip end coordinate system) of the robot 1, the input/output portion 54 that functions as “obtaining portion” obtains the second captured image 40 (image data) obtained by capturing the image of the marker 61 by the second image capturing portion 4, and the control portion 53 calculates the position of the marker 61 in the coordinate system (tip end coordinate system) of the robot 1 based on the second captured image 40 obtained by the input/output portion 54 (step S12). Accordingly, it is possible to easily and appropriately acquire the position of the marker 61 with respect to the predetermined part (tool center point TCP in the embodiment) of the robot 1, that is, the offset of the marker 61. Therefore, by using the offset of the marker 61, it is possible to appropriately perform the first corresponding.

In addition, as described above, the control portion 53 calculates the offset of the predetermined part (tool center point TCP in the embodiment) of the robot 1 and the marker 61 based on the position of the marker 61 in the tip end coordinate system after calculating the position of the marker 61 in the coordinate system (tip end coordinate system) of the robot 1 (step S12), and performs the first corresponding based on the offset and the first captured image 30 (step S13) . Accordingly, as illustrated in FIG. 10, even when it is not possible to capture the predetermined part by the first image capturing portion 3, it is possible to appropriately perform the first corresponding in step S13 based on the position and the offset of the marker 61 acquired in step S12. In addition, “predetermined part” is not limited to the tool center point TCP, maybe an arbitrary location in the robot 1, and for example, may be a tip end of the splicing shaft 103 (arm of the tip end).

In addition, as described above, in step S13, the control portion 53 performs the first corresponding at the first position, and controls the driving of the robot 1 by using the first corresponding at the first position, at the second position different from the first position. In step S13, since it is possible to acquire the first corresponding at the second position different from the first position based on the data of the first corresponding at the first position, it is possible to save time and effort for performing the first corresponding at the second position, and to improve the accuracy of the work of the robot 1 at the second position similar to the work at the first position. Furthermore, as described above, it is possible to perform the first corresponding at another position different from the first position and the second position based on the data of the first corresponding at the first position. Therefore, it is possible to perform the action even with one first image capturing portion 3 similar to a case where the plurality of first image capturing portions 3 are provided. As a result, at the plurality of locations, it is possible to appropriately perform the work in the robot 1 based on the first captured image 30. In addition, in this manner, by performing the first corresponding at the plurality of locations based on the calibration result at the first position, it is possible to finish the first corresponding of the first image capturing portion 3 at the location at which the interference with the peripheral device easily occur, and thus, it is possible to avoid a concern that the calibration is practically executed and the peripheral device is interfered.

In addition, in the control device 5, it is preferable that 0.8≤R1/R2≤1.2 when the repeating accuracy in movement of the first image capturing portion 3 is R1 and the repeating accuracy in work of robot 1 is R2.

By satisfying the relationship, it is possible to particularly improve the accuracy of the first corresponding at the plurality of positions based on the data of the first corresponding at one arbitrary position (first position). Therefore, it is possible to improve the accuracy of the work of the robot 1 at the plurality of positions similar to the work at the arbitrary position (first position).

Here, the repeating accuracy in the movement of the first image capturing portion is the movement accuracy of the moving mechanism 7, and illustrates how much the positional shift is generated when the first image capturing portion is repeatedly positioned at the same location. In addition, the repeating accuracy in the work of the robot is the repeating accuracy when performing the same work contents at the same location. For example, in the embodiment, it is illustrated how much the positional shift of the other targets is generated with respect to the target 800 when the other targets (not illustrated) are mounted on (adhere to) the target 800 on the conveyor 81.

The repeating accuracy in the movement of the first image capturing portion 3 is, for example, preferably 5 to 50 μm, and more preferably 10 to 20 μm. The repeating accuracy in the work of the robot is, for example, preferably 5 to 50 μm, and more preferably 10 to 20 μm. When the repeating accuracy is set in this manner, it is possible to set the comprehensive accuracy by the robot system 100 including the movement of the first image capturing portion 3, the work of the robot 1, and other reasons (for example, the calibration accuracy and the image recognizing accuracy of the first image capturing portion 3 or the second image capturing portion 4), to a relatively high accuracy. Specifically, the comprehensive accuracy can be 10 to 40 μm.

Above, the configuration of the robot 1 is briefly described. The robot 1 which is one example of the robot according to the invention is controlled by the control device 5, and includes the robot arm 10 that functions as “movable portion” provided with the jig 6 that functions as “tool” including the marker 61. According to the robot 1, under the control of the control device 5, it is possible to accurately perform the operation related to the first corresponding.

The robot system 100 which is one example of the robot system according to the invention described above includes the control device 5; the robot 1 which is controlled by the control device 5, and includes the robot arm 10 that functions as “movable portion” provided with the jig 6 that functions as “tool” including the marker 61; and the first image capturing portion 3 having an image capturing function. According to the robot system 100, it is possible to perform the first corresponding at a location at which the first image capturing portion 3 is moved and does not interfere with the peripheral device or the like, and under the control of the control device 5, the robot 1 can accurately perform the operation related to the first corresponding.

### Second Embodiment

Next, a second embodiment of the invention will be described.

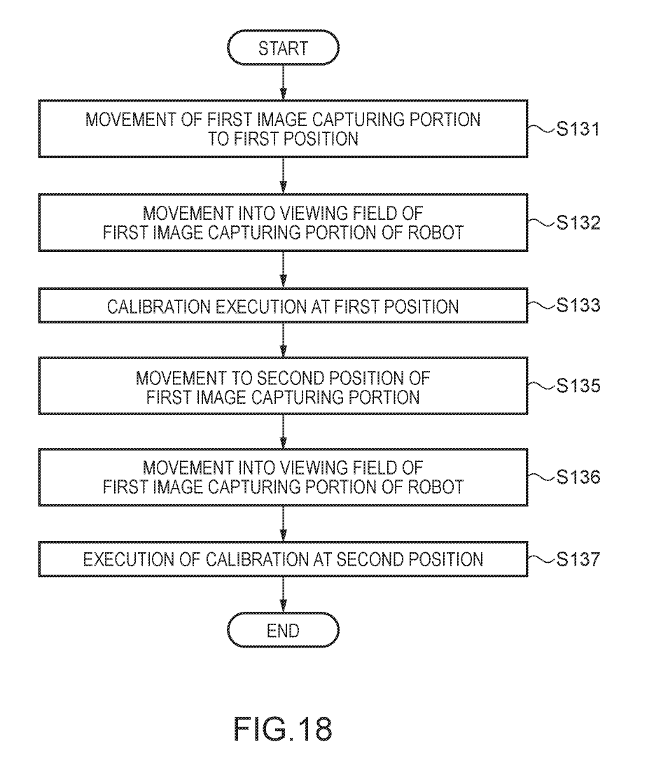

FIG. 18 is a flowchart for describing step S13 in calibration in the robot system according to a second embodiment of the invention.

The robot system according to the embodiment is similar to the above-described first embodiment except that step S13 of the first corresponding is different. In addition, in the following description, regarding the second embodiment, differences from the above-described first embodiment will be focused in the description, and the description of similar contents will be omitted.

### Movement to Second Position of First Image Capturing Portion (FIG. 18: Step S135)

When the execution of the calibration at the first position is finished (step S133), the first image capturing portion 3 is moved to the second position. In addition, in the embodiment, by the disposition of the peripheral device or the like, even at the second position, the robot 1 does not interfere with the peripheral device.

### Movement into Viewing Field of First Image Capturing Portion of Robot (FIG. 18: Step S136)

Next, when the movement of the moving mechanism 7 is finished, the control portion 53 drives the robot arm 10 to position the marker 61 of the jig 6 within the viewing field of the first image capturing portion 3 at the second position.

### Execution of Calibration at Second Position (FIG. 18: Step S137)

Next, the control portion 53 performs the first corresponding at the second position. Accordingly, even at the second position, it is possible to acquire the position at the robot coordinates of the image capturing target projected to the first captured image 30.

In this manner, in the embodiment, the first corresponding at the first position and at the second position is performed. In other words, the control portion 53 performs the first corresponding at the plurality of positions. In this manner, by practically executing the first corresponding every time when moving the first image capturing portion 3, it is possible to particularly improve the accuracy of the first corresponding at each of the locations. Therefore, it is possible to particularly improve the accuracy of the work of the robot 1. In addition, even by the method, it is possible to perform an action with one first image capturing portion 3 similar to a case where the plurality of first image capturing portions 3 are provided. As a result, at the plurality of locations, it is possible to appropriately perform the work with respect to the robot 1 based on the first captured image 30.

Above, the control device, the robot, and the robot system according to the invention are described based on the embodiments illustrated in the drawings, but the invention is not limited thereto, and configurations of each portion can be replaced to arbitrary configurations having similar functions. In addition, in the invention, other arbitrary configurations may be added. In addition, each of the embodiments may be appropriately combined with each other.

In addition, the robot according to the invention has a configuration including the movable portion (for example, the robot arm) which is rotatable with respect to the arbitrary member (for example, the base), may have a configuration in which attachment of the tool with a marker is possible, and is not limited to the aspect of the robot illustrated in the drawings. For example, the robot according to the invention may be a selective compliance assembly robot arm robot.

In addition, the number of robot arms is not particularly limited, and may be two or more. In addition, the number of rotation axes of the robot arm is not particularly limited, and is arbitrary.

In addition, the installation location of the robot is not limited to a ceiling portion of the cell. For example, according to the image capturing direction of the first image capturing portion, the robot may be attached to the upper surface of the bottom portion or a pillar.

In addition, the robot system according to the invention may not include the cell. In this case, the installation location of the robot maybe an arbitrary location (on the floor, the wall, the ceiling, the movable cart or the like).

In addition, the robot system according to the invention may not include a conveyor. In addition, the robot system according to the invention may not include the work portion.

The entire disclosure of Japanese Patent Application No. 2016-239107, filed Dec. 9, 2016 is expressly incorporated by reference herein.

What is claimed is:

1. A control device which controls a robot including a movable portion provided with a tool including a marker, the device comprising:
an obtaining portion which obtains a first captured image obtained by capturing an image of the marker by a movable first image capturing portion that captures an image of the marker; and
a control portion which performs first corresponding between a coordinate system of the first image capturing portion and a coordinate system of the robot based on the first captured image obtained by the obtaining portion after the first image capturing portion has moved.

2. The control device according to claim 1,
wherein the control portion performs the first corresponding at a plurality of positions.

3. The control device according to claim 1,
wherein the control portion performs the first corresponding at a first position, and controls driving of the robot by using the first corresponding at the first position, at a second position different from the first position.

4. The control device according to claim 3, wherein 0.8≤R1/R2≤1.2 when the repeating accuracy in movement of the first image capturing portion is R1 and the repeating accuracy in work of robot is R2.

5. The control device according to claim 1,
wherein, after the control portion performs second corresponding between a coordinate system of a second image capturing portion which captures an image of the marker and the coordinate system of the robot, the obtaining portion obtains a second captured image obtained by capturing an image of the marker by the second image capturing portion, and the control portion calculates a position of the marker in the coordinate system of the robot based on the second captured image obtained by the obtaining portion.

6. The control device according to claim 1,
wherein, after calculating the position of the marker in the coordinate system of the robot, the control portion calculates an offset between a predetermined part of the robot and the marker based on the position of the marker in the coordinate system of the robot, and performs the first corresponding based on the offset and the first captured image.

7. The control device according to claim 1,
wherein the marker is a transmitting portion having optical transmission properties.

8. The control device according to claim 7,
wherein the first image capturing portion is provided at a location different from the movable portion.

9. A robot comprising:
a movable portion which is controlled by the control device according to claim 1, and which is provided with a tool including a marker.

10. A robot comprising:
a movable portion which is controlled by the control device according to claim 2, and which is provided with a tool including a marker.

11. A robot comprising:
a movable portion which is controlled by the control device according to claim 3, and which is provided with a tool including a marker.

12. A robot comprising:
a movable portion which is controlled by the control device according to claim 4, and which is provided with a tool including a marker.

13. A robot comprising:
a movable portion which is controlled by the control device according to claim 5, and which is provided with a tool including a marker.

14. A robot comprising:
a movable portion which is controlled by the control device according to claim 6, and which is provided with a tool including a marker.

15. A robot system comprising:
the control device according to claim 1;
a robot which is controlled by the control device, and includes a movable portion provided with a tool including a marker; and
a first image capturing portion having an image capturing function.

16. A robot system comprising:
the control device according to claim 2;
a robot which is controlled by the control device, and includes a movable portion provided with a tool including a marker; and
a first image capturing portion having an image capturing function.

17. A robot system comprising:
the control device according to claim 3;
a robot which is controlled by the control device, and includes a movable portion provided with a tool including a marker; and
a first image capturing portion having an image capturing function.

18. A robot system comprising:
the control device according to claim 4;
a robot which is controlled by the control device, and includes a movable portion provided with a tool including a marker; and
a first image capturing portion having an image capturing function.

19. A robot system comprising:
the control device according to claim 5;
a robot which is controlled by the control device, and includes a movable portion provided with a tool including a marker; and
a first image capturing portion having an image capturing function.

20. A robot system comprising:
the control device according to claim 6;
a robot which is controlled by the control device, and includes a movable portion provided with a tool including a marker; and
a first image capturing portion having an image capturing function.
